(19) United States
(12) Patent Application Publication
(10) Pub. No.: US 2018/0086563 A1
(43) Pub. Date: Mar. 29, 2018

(54) Transport Bag for an Overhead Conveyor

(71) Applicant: Dürkopp Fördertechnik GmbH, Bielefeld (DE)

(72) Inventors: Paul Janzen, Bielefeld (DE); Michael Wend, Bielefeld (DE)

(21) Appl. No.: 15/718,287

(22) Filed: Sep. 28, 2017

(30) Foreign Application Priority Data
Sep. 29, 2016 (DE) 10 2016 218 879.8

(51) Int. Cl. B65G 9/00; B65D 33/02; B65D 33/14

(52) U.S. Cl. CPC B65G 9/002; B65G 2812/182; B65D 33/14; B65D 33/02

(57) ABSTRACT

A transport bag for an overhead conveyor comprises a front side wall, a rear side wall and a bottom wall that interconnects the front side wall with the rear side wall, wherein an adherent contact surface is at least partly provided on an outer side of the front side wall and/or on an outer side of the rear side wall to prevent a lateral displacement of two transport bags abutting against each other.

### CROSS REFERENCE TO RELATED APPLICATIONS

This application claims priority of German Patent Application Serial No. 10 2016 218 879.8 filed on Sep. 29, 2016, pursuant to 35 U.S.C. (a)-(d), the content of which is incorporated herein by reference in its entirety as if fully set forth herein.

### FIELD OF THE INVENTION

The invention relates to a transport bag for an overhead conveyor.

### BACKGROUND OF THE INVENTION

A transport bag for an overhead conveyor is known from DE 10 2008 026 720 A1. The transport bag has a flexible bag material so the shape of the bag changes depending on the type of products disposed therein. In an accumulation zone of an overhead conveyor, an accumulation pressure may act on the accumulated transport bags. The accumulation pressure is caused by a downhill force in the accumulation zone or by an accumulation path drive, for example. Transport bags that are bulged because of the products transported therein may slide out of position and/or get caught with each other in a direction transverse to the transport direction. The transport of bags using the overhead conveyor is prone to errors. In order to prevent the transport bags from sliding out of position due to the accumulation pressure, it is known from DE 10 2010 053 590 A1 to provide spacers between the individual transport bags to maintain a defined minimum distance between adjacent transport bags along the transport direction.

### SUMMARY OF THE INVENTION

The present invention is based on the object of improving the transport of bags and, in particular, to prevent the transport bags from laterally sliding out of position and/or from getting caught with each other in an uncontrolled manner.

This object is achieved according to the invention by a transport bag for an overhead conveyor, the transport bag comprising a front side wall; a rear side wall; a bottom wall interconnecting the front side wall with the rear side wall, wherein an adherent contact surface is at least partly provided on an outer side of the front side wall and/or on an outer side of the rear side wall to prevent a lateral displacement of two transport bags abutting against each other.

It was found according to the invention that a lateral displacement of two transport bags abutting against each other can be prevented by providing the transport bags with an adherent contact surface. The adherent contact surface is formed at least partly on an outer side of a front side wall and/or a rear side wall. The side walls are in particular made of a limp and/or bulgeable material. A material of this type is a textile fabric or a nonwoven textile fabric, for example. In particular, the side walls are configured such as to be non-rigid. The adherent contact surface of the transport bag may abut against the adjacent transport bag, either directly against the bag material or against an adherent contact surface of the adjacent transport bag. In the region of the adherent contact surface, the transport bag adheres removably to the adjacent transport bag. The adherence is in particular greater than a resulting displacement force that is oriented in particular transverse and in particular perpendicular to a conveying direction of the overhead conveyor. The resulting displacement force is in particular caused by the accumulation pressure. In the unloaded condition, the transport bag has a substantially cuboid shape with a front side wall oriented towards the front when seen in the transport direction of the overhead conveyor, a rear wall opposite thereto and a bottom wall that interconnects the front side wall with the rear side wall.

The transport bag according to the invention may be arranged reliably in an accumulation path. A lateral displacement of the transport bags due to an accumulation pressure, which is unknown a priori, is excluded.

It is in particular sufficient if the transport bag is provided with the adherent contact surface only partly. The adherent contact surface is in particular arranged on the bag in a position where it can be expected that transport bags abutting against each other contact each other when the transport bags are accumulated in the accumulation zone of the overhead conveyor. It is conceivable as well for the adherent contact surface to extend across the entire front side wall and/or the entire rear side wall and, in particular, across the entire transport bag. In this case, the transport bag may uniformly be made of a material forming the adherent contact surface. The uniform material prevents the transport bags from laterally sliding out of position.

It was found according to the invention that spacers according to DE 10 2010 053 590 A1 may be omitted if the transport bags themselves are configured in such a way that a lateral displacement thereof is excluded. The adherent contact surface allows a plurality of transport bags to be arranged stably along an accumulation path substantially irrespective of the accumulation pressure. Accumulating the transport bags is possible with reduced effort in a reliable manner. The transport bags are arrangeable along an accumulation path in a reliable, error-free and uncomplicated manner.

The embodiment of the adherent contact surface provided with a friction layer made of a friction material allows the lateral displacement to be avoided in a particularly reliable manner. Transport bags abutting against each other are held directly against each other in the region of the adherent contact surface. A lateral yielding is avoided.

The embodiment of a transport bag displaying a high coefficient of friction that amounts to at least 0.6, in particular at least 0.8, and in particular to at least 1.0 ensures a reliable accumulation of the transport bags in an accumulation zone. In particular, the coefficient of friction of the friction layer is higher than that of typical bag materials that have a coefficient of friction of up to 0.4, for example. The friction layer is in particular made of polyvinyl chloride (PVC), in particular of soft PVC (PVC-P). The coefficient of friction within the scope of the application is in particular the coefficient of sliding friction for a dry, in other words non-lubricated, material combination, in particular the material used for the friction layer combined with steel. This value is 0.6 for PVC, for example. For rubber materials, which are generally suitable materials for the friction layer, the coefficient of friction may be in the range of approximately 0.8 to 2.5, for example, depending on the speed and/or temperature. A typical rubber material is acrylic nitrile butadiene (NBR), for example. Another suitable material for the friction layer is silicone rubber and/or acrylic rubber. A coefficient of friction greater than 1 ensures a particularly good adherence.

The embodiment of the transport bag provided with a friction layer that is attached to or integrated in the front side wall and/or the rear side wall ensures an efficient use of the friction material. The friction layer is in particular attached to one of the side walls or integrated therein.

A transport bag provided with a friction layer that is flame-inhibiting and in particular halogen-free has advantageous safety properties, in particular in terms of a potential fire risk.

The embodiment of the transport bag provided with an adherent contact surface that has at least one elevation and/or at least one recess allows adjacent transport bags to be connected to each other in a mechanically controlled manner. The adherent contact surface in particular has a surface texture. The adherent contact surface has in particular at least one elevation and/or one recess. The at least one recess may in particular be formed by an intermediate space between the elevations of the adherent contact surface. In particular, the elevations are arranged on the adherent contact surface in the manner of a grid so the recesses formed therebetween are configured in the manner of a grid as well. When adjacent transport bags abut against each other, the elevations of the adherent contact surface of one bag may engage the recesses of the adherent contact surface of the other transport bag so as to form a mechanical connection, in particular a positive connection, that prevents a lateral displacement of the transport bags. The elevations may be configured in the shape of a pyramid, cone, cuboid and/or cylinder, for example. The elevations and/or recesses allow the bags to lock with each other. The adherence of the transport bags to each other is thus improved.

Instead of a surface texture comprising a plurality of elevations and recesses, it is conceivable as well to provide only a few elevations and/or recesses, in particular precisely one elevation and/or precisely one recess, on the adherent contact surface. The elevation may be configured as a pin, for example, that projects from the adherent contact surface and may engage a recess in the shape of a rounded elongate hole, serving as complementary contour, of the adjacent transport bag.

The adherence of adjacent transport bags is improved if recesses of the adherent contact surface of one transport bag interact directly with corresponding elevations of the adherent contact surface of the other transport bag. In particular, elevations and recesses on one adherent contact surface of a transport bag are arranged adjacent to each other in an in particular regular grid. It is advantageous if the respective grid distances of elevations and recesses of the corresponding adherent contact surfaces are configured identically. Furthermore, it is advantageous if the respective contour of the elevations interacts with the respective contour of the corresponding recesses. In this respect, it is advantageous if the recesses are negatives of a respective elevation.

The elevations and recesses increase the surface area of the adherent contact surface. The increased surface area ensures an improved adherence of the adjacent transport bags. The adherent contact surface ensures an improved adherence even if the adjacent transport bag is configured without elevations and/or recesses. In particular, it is possible that the elevations and/or recesses of the adherent contact surface are elastically deformed when adhering to the adjacent transport bag. A lateral displacement caused by the accumulation pressure is thus avoided.

It is particularly advantageous if the adherent contact surface is provided with a friction layer of a friction material, the friction layer being provided with elevations and/or recesses. The adherence is improved even more. The adherent contact surface provides a retaining force as a result of the non-positive connection due to friction and as a result of the positive connection due to elevations and/or recesses.

A reinforcing plate that is arranged in particular in the region of the adherent contact surface provides an additional mechanical stabilization of the transport bag. Due to the fact that a reinforcing plate is arranged in the region of the adherent contact surface, a reliable adherence of the transport bags in the region of the adherent contact surfaces is improved. The reinforcing plate provides a substantially defined plane contact surface of the transport bag, in particular irrespective of the products the bag is loaded with.

The embodiment of the transport bag in which at least part of the transport bag has a multilayer design, wherein the adherent contact surface and the reinforcing plate are arranged one behind the other along the thickness of the front side wall and/or the rear side wall provides a particularly rugged and compact design. The multilayer configuration ensures that the outer adherent contact surface is supported by the reinforcing plate disposed underneath. This prevents the adherent contact surface from bending and/or deforming in an undefined manner due to the loading of the transport bag.

An embodiment of the transport bag provided with a reinforcing plate that has a bending stiffness that is greater than that of the adherent contact surface and/or that of the bag material ensures a reinforcement of the adherent contact surface.

An embodiment of the transport bag provided with a reinforcing plate that is configured as a PP hollow-chamber web plate or as a corrugated cardboard ensures a particularly light and cost-efficient design. The reinforcing plate may be made of paperboard or cardboard. The reinforcing plate may have a hollow chamber oriented perpendicular to the board plane. The hollow chambers may for instance be configured in a honeycomb-like manner. The hollow chambers may also have another contour, for example an annular or rectangular or square contour. The reinforcing plate may also be made of another material such as plastic material, and in particular of polypropylene. It is conceivable as well to use a reinforcing plate of metal, in particular of a metal foam material.

An embodiment of the transport bag provided with a reinforcing plate that is entirely covered by the adherent contact surface ensures an error-free reinforcement of the adherent contact surface.

An embodiment of a transport bag provided with a front adherent contact surface that is provided on the front side wall while a rear adherent contact surface is provided on the rear side wall, wherein the front adherent contact surface and the rear adherent contact surface are configured substantially, in particular entirely, identical, increases the safety when conveying the transport bags. Due to the fact that a front adherent contact surface and a rear adherent contact surface are provided, the respective front and rear contact surfaces of adjacent transport bags may directly abut against each other. The adherence of the transport bags against each other, and therefore the protection against a lateral displacement, are increased even more. It is advantageous if the adherent contact surfaces are configured identically, wherein the adherent contact surfaces may differ from each other in terms of their dimensions and/or their arrangement. In this manner, it can be advantageous if the front adherent contact surface on the front side wall is arranged more closely to the bottom wall than the rear adherent contact surface, which is in contact with the adherent contact surface of the following transport bag arranged at a more elevated position due to a slope of the conveyor rail.

A transport bag provided with an adherent contact surface that has at least one adherent element that is adherently connectable, by means of a positive fit and/or a non-positive fit, with a counter adherent element of a transport bag abutting thereagainst in such a way as to be removable, wherein the adherent element and the counter adherent element are in particular magnetic or configured as a hookand-loop fastener, provides an improved and in particular removable adherence of the adjacent transport bags to each other. An adherent element configured magnetically and/or in the manner of a hook-and-loop fastener, for example, is advantageous.

The embodiment of the transport bag in which on a respective free end opposite to the bottom wall, the front side wall and the rear side wall are directly connected to each other by means of at least one carrier frame allows an advantageous overhead suspension from a conveyor rail of the overhead conveyor.

An embodiment of the transport bag provided with a coupling unit to be coupled to a conveyor unit, in particular a roll adapter, of the overhead conveyor allows a direct coupling of the transport bag to the overhead conveyor.

Further advantages, additional features and details of the invention will be apparent from the ensuing description of an exemplary embodiment, taken in conjunction with the drawing.

### BRIEF DESCRIPTION OF THE DRAWINGS

FIG. 1 shows a perspective view of an accumulation path of an overhead conveyor with a plurality of transport bags accumulated there;

FIG. 2 shows a plan view of the accumulation path according to FIG. 1;

FIG. 3 shows a perspective view of a transport bag according to the invention;

FIG. 4 shows a front view of the transport bag according to FIG. 3;

FIG. 5 shows a rear view of the transport bag according to FIG. 3;

FIG. 6 shows a side view of the unloaded transport bag according to FIG. 3;

FIG. 7 shows a perspective detail view of a friction layer of the adherent contact surface of the transport bag according to FIG. 3; and

FIG. 8 shows an enlarged detail view of adherent contact surfaces of adjacent transport bags according to FIG. 1, the adherent contact surfaces being arranged such as abut against each other.

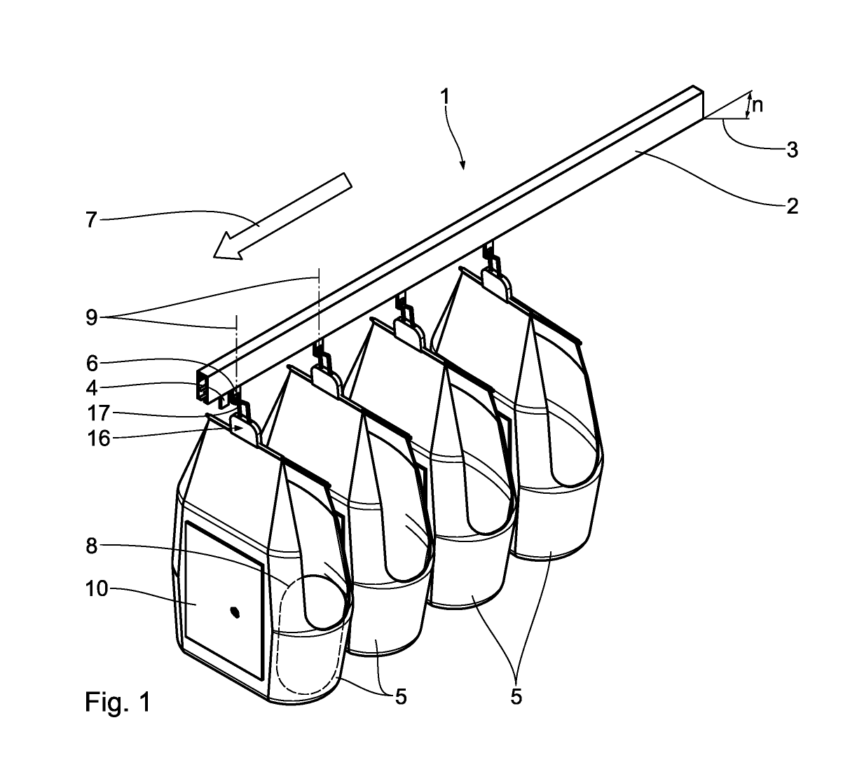

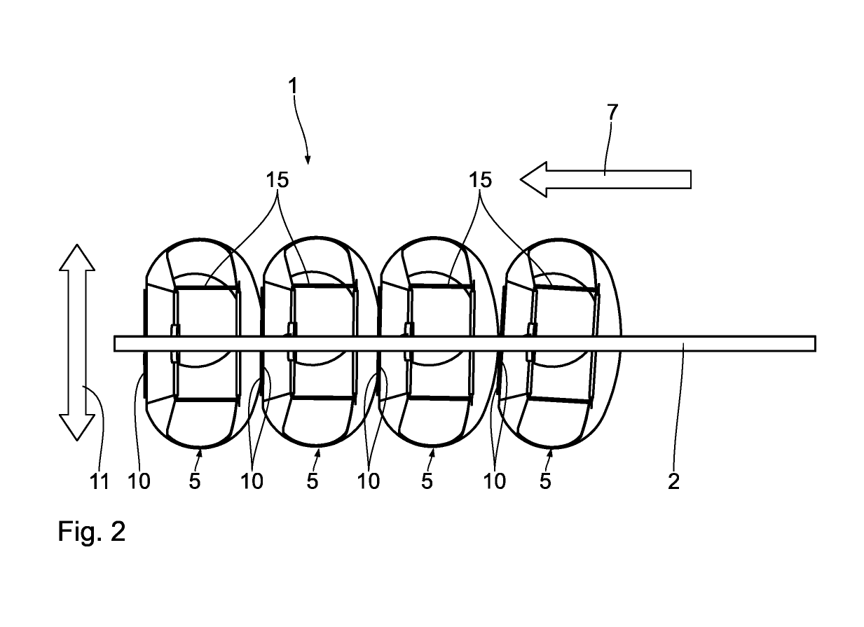

An accumulation zone 1 shown in FIGS. 1 and 2 forms part of an overhead conveyor. The accumulation zone 1 has an upper conveyor rail 2 that is arranged at an angle of inclination n with respect to the horizontal 3.

### DESCRIPTION OF AT LEAST ONE PREFERRED EMBODIMENT

The accumulation zone 1 has an actuable stopper element 4 to stop transport bags 5 that are transported along the conveyor rail 2. The transport bags 5 are transportable along the conveyor rail 2 in a guided manner by means of a respective adapter element 6. The conveyor rail 2 defines a transport direction 7.

Each of the transport bags 5 carries transport products 8. The transport products 8 in particular have different sizes. In particular, the transport products 8 have a thickness, oriented along the transport direction 7, that is greater than the initial thickness of the transport bag 5 in the unloaded condition. When loaded with the transport products 8, the outer contour of the transport bag 5 changes with respect to the unloaded condition. In the loaded condition, the transport bag 5 has a deformed, in particular bulged shape.

In the region of the accumulation path 1, the transport bags 5 with the adapter elements 6 are arranged along the conveyor rail 2 at substantially equal distances from each other. The distance of the transport bags 5 is directly proportional to the loading thereof. When the transport bags 5 are loaded with transport products 8 having different thicknesses along the transport direction 7, the transport bags may be arranged at varying distances from each other. The distance corresponds approximately to the bag width in the loaded condition. Due to the bulged shape of the transport bags 5, they abut against each other. In particular the transport bags arranged further down the line are arranged such as to be substantially non-inclined with respect to the vertical 9.

The transport bags 5 are provided with 2 adherent contact surfaces 10 each. The adherent contact surfaces 10 of two transport bags 5 arranged adjacent to each other abut against each other. This prevents the transport bags 5 from being displaced along a transverse direction 11, which is oriented perpendicular to the transport direction 7, due to the accumulation pressure.

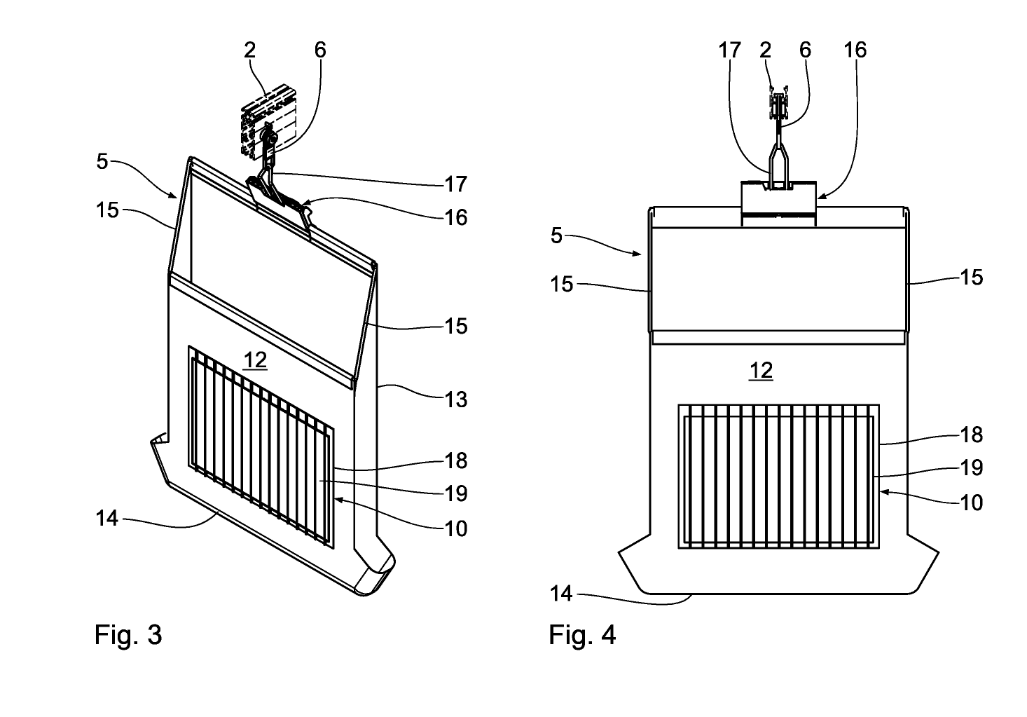

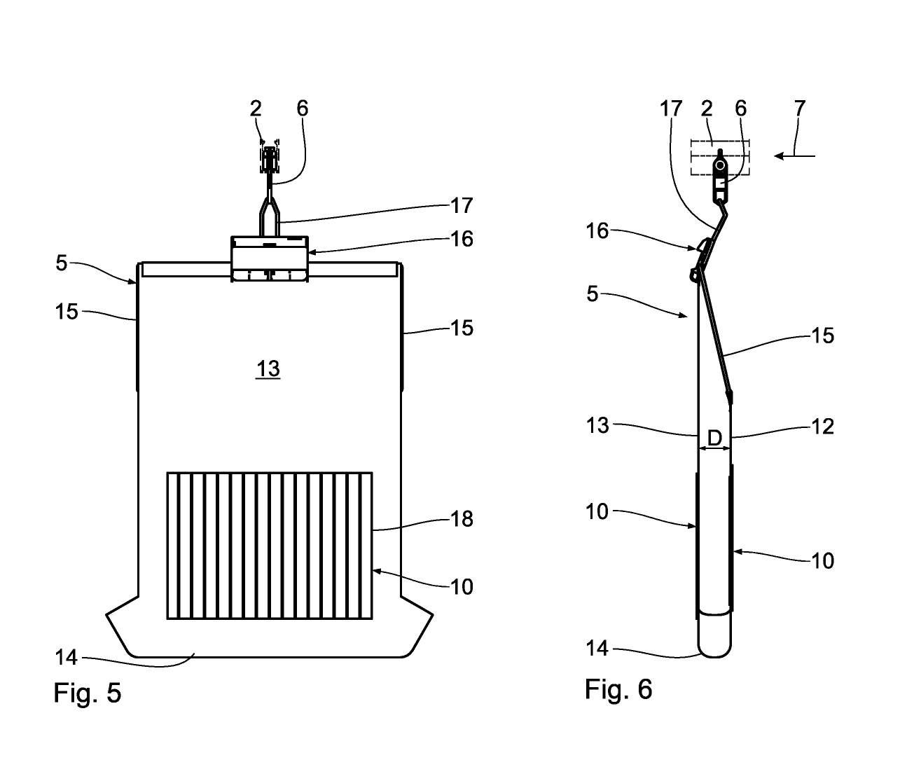

The design of the transport bag 5 will hereinafter be explained in more detail by means of FIG. 3 to FIG. 8. The transport bag 5 has a front side wall 12, a rear side wall 13 and a bottom wall 14 that interconnects the front side wall 12 with the rear side wall 13. The front side wall 12, the rear side wall 13 and the bottom wall 14 are made of a uniform flexible bag material. In an upper region opposite to the bottom wall 14, the front side wall 12 and the rear side wall 13 are secured to two opposite carrier frames 15. The rear side wall 13 has a coupling unit 16 with a hook element 17 to be hooked into the adapter element 6. The adapter element 6 is in particular a roll adapter that constitutes a conveyor unit.

In the region of the bottom wall 14, the transport bag 5 has lateral compensation elements 18 that allow the bag to widen in a thickness direction. The thickness D of the transport bag 5 in the unloaded condition is shown in FIG. 6. The adherent contact surfaces 10 of the transport bag 5 are in each case arranged on a respective outer side of the front side wall 12 and the rear side wall 13. According to the exemplary embodiment shown, the adherent contact surfaces 10 are configured as friction layers made of PVC-P. The adherent contact surfaces 10 on the front side wall 12 and the rear side wall 13 are in particular configured identically and only differ from each other in terms of their position on the front side wall 12 and the rear side wall 13.

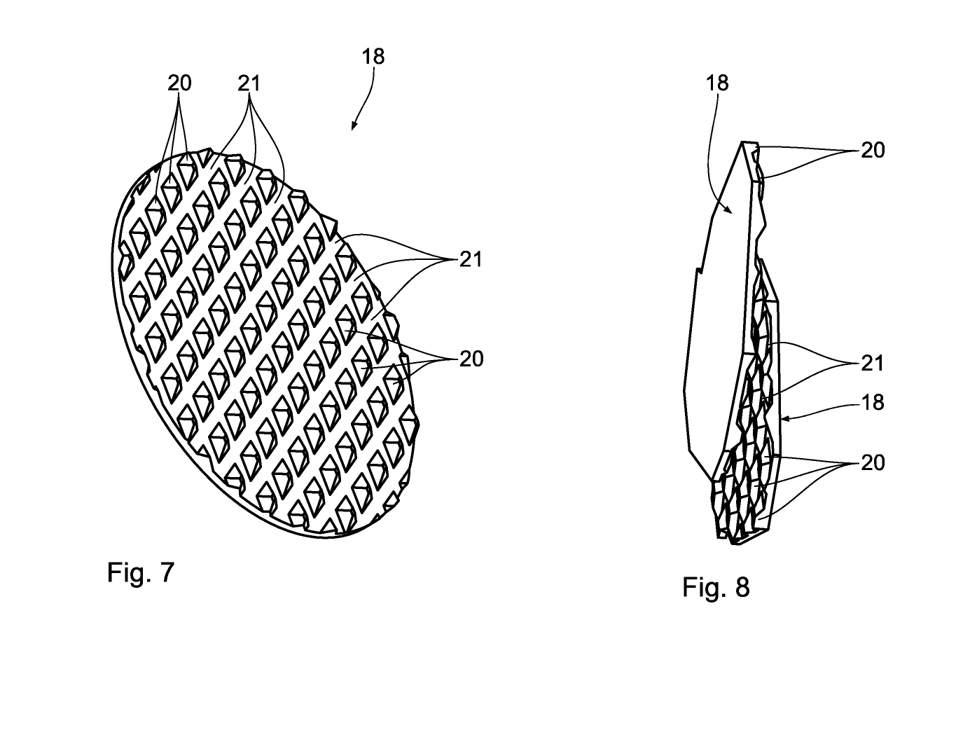

In order to improve the adherence of two adjacent adherent contact surfaces 10, the friction layers 18 are each provided with a surface texture that is shown in more detail in FIGS. 7 and 8. The surface texture of the adherent contact surface 10 may also be configured in such a way that the adherent contact surface 10 is wavy, concave or convex, for example.

In particular on the front side wall 12, a reinforcing plate, which—according to the exemplary embodiment shown—is configured as a polypropylene hollow-chamber web plate, is arranged underneath the adherent contact surface, in other words underneath the friction layer 18. The size of the reinforcing plate 19 substantially corresponds to the size of the friction layer 18 so the friction layer 18 is reinforced by the reinforcing plate 19 substantially across the entire surface thereof. According to the exemplary embodiment shown, the reinforcing plate 19 has a width of 200 mm and a height of 300 mm. The rectangular surface area of the reinforcing plate 19, which is defined by the height and width thereof, is in particular slightly smaller than the surface area of the friction layer 18, in other words the adherent contact surface. This ensures that the reinforcing plate 19 is entirely covered by the friction layer 18.

The reinforcing plate 19 has a thickness of 3.0 mm.

The dimensions of the reinforcing plate 19 and/or the friction layer 18 may also be chosen greater or smaller. In particular, the dimensions of the reinforcing plate 19 and/or the friction layer 18 are adjusted to the size of the transport bag, in other words the height and width of the side walls 12, 13.

FIG. 7 shows an enlarged sectional view of the friction layer 18 with a plurality of pyramid-shaped elevations 20. The elevations 20 are arranged in rows and columns in a grid-like manner. Both in the direction of the rows and in the direction of the columns, a respective intermediate space 21 is formed between the elevations 20. The intermediate spaces 21 form recesses between the elevations 20. The adherence of transport bags 5 abutting against each other along an accumulation path 1 can be improved in such a way that the elevations 20 of one adherent contact surface engage the intermediate spaces 21 of the adherent contact surface 10 of the adjacent transport bag (see FIG. 8). The retaining force or adherence of the transport bags abutting against each other is thus increased. The intermediate spaces 21 may have a width of 0.5 mm to 1 mm and a depth of approximately 0.5 mm. In the region of the adherent contact surface 10, the material thickness of the transport bag 5 is approximately 1.5 mm. In this region, the transport bag 5 has a multilayer design comprising the adherent contact surface 10 of the friction layer 18 arranged on the outside, the reinforcing plate 19 arranged therebelow and the bag material arranged therebelow. The bag material is a flexible textile fabric.

If in particular precisely one elevation and/or precisely one recess are provided on the adherent contact surface, the width and height thereof may for instance amount to several millimeters, in particular between 5 mm and 50 mm. The width of the recess configured in the shape of an elongate hole is configured correspondingly.

The material that is provided with the adherent contact surface 10 has in particular restoring properties, in other words it is in particular fully elastic so after removing the transport products 8 from the transport bags 5, it reverts back to its initial shape that corresponds to the unloaded initial condition.

The friction layer 18 is in particular made of an elastomer material. It is conceivable as well to integrate the reinforcing plate 19 into the friction layer 18 in such a way that the reinforcing plate 19 is extrusion-coated with the material of the friction layer 18.

1. A transport bag for an overhead conveyor, the transport bag comprising:
a front side wall;
a rear side wall;
a bottom wall interconnecting the front side wall with the rear side wall,
wherein an adherent contact surface is at least partly provided on at least one of 1) an outer side of the front side wall and 2) an outer side of the rear side wall in order to prevent a lateral displacement of two transport bags abutting against each other.

2. The transport bag according to claim 1, wherein the adherent contact surface has a friction layer made of a friction material.

3. The transport bag according to claim 2, wherein the friction layer has a static coefficient of friction of at least 0.6.

4. The transport bag according to claim 3, wherein the static coefficient of friction is at least 0.8.

5. The transport bag according to claim 3, wherein the static coefficient of friction is at least 1.0.

6. The transport bag according to claim 2, wherein the friction layer is attached to at least one of the front side wall and the rear side wall.

7. The transport bag according to claim 2, wherein the friction layer is integrated into at least one of the front side wall and the rear side wall.

8. The transport bag according to claim 2, wherein the friction layer is flame-inhibiting.

9. The transport bag according to claim 2, wherein the friction layer is halogen-free.

10. The transport bag according to claim 1, wherein the adherent contact surface has at least one of 1) at least one elevation and 2) at least one recess.

11. The transport bag according to claim 1, further comprising a reinforcing plate.

12. The transport bag according to claim 11, wherein the reinforcing plate is arranged in a region of the adherent contact surface.

13. The transport bag according to claim 11, wherein at least part of the transport bag has a multilayer design, and wherein the adherent contact surface and the reinforcing plate are arranged one behind the other along a thickness of at least one of the front side wall and the rear side wall.

14. The transport bag according to claim 11, wherein the reinforcing plate has a bending stiffness that is greater than that of at least one of the adherent contact surface and a bag material.

15. The transport bag according to claim 11, wherein the reinforcing plate is configured as one of a PP hollow-chamber web plate and a corrugated cardboard.

16. The transport bag according to claim 11, wherein the reinforcing plate is entirely covered by the adherent contact surface.

17. The transport bag according to claim 1, wherein the adherent contact surface comprises a front adherent contact surface provided on the front side wall, and further comprising a rear adherent contact surface provided on the rear side wall.

18. The transport bag according to claim 17, wherein the front adherent contact surface and the rear adherent contact surface are configured entirely identically to one another.

19. The transport bag according to claim 1, wherein the adherent contact surface has at least one adherent element that is adherently connectable, via at least one of a positive fit and a non-positive fit, with a counter adherent element of a transport bag abutting thereagainst in such a way as to be removable.

20. The transport bag according to claim 19, wherein the adherent element and the counter adherent element are magnetic.

21. The transport bag according to claim 19, wherein the adherent element and the counter adherent element are configured as a hook-and-loop fastener.

22. The transport bag according to claim 1, wherein, on a respective free end opposite to the bottom wall, the front side wall and the rear side wall are directly connected to each other via at least one carrier frame.

23. The transport bag according to claim 1, further comprising a coupling unit via which the transport bag can be coupled to a conveyor unit of the overhead conveyor.

24. The transport bag according to claim 23, wherein the conveyor unit is configured as a roll adapter.
